(19) United States
(12) Patent Application Publication
(10) Pub. No.: US 2015/0167977 A1
(43) Pub. Date: Jun. 18, 2015

(54) ANNULAR WALL FOR TURBOMACHINE COMBUSTION CHAMBER COMPRISING COOLING ORIFICES CONDUCIVE TO COUNTER-ROTATION

(71) Applicant: SNECMA, Paris (FR)

(72) Inventors: Francois LEGLAYE, Vaux Le Penil (FR); Patrick Lutz, Rubelles (FR)

(73) Assignee: SNECMA, Paris (FR)

(21) Appl. No.: 14/564,588

(22) Filed: Dec. 9, 2014

(30) Foreign Application Priority Data
Dec. 12, 2013 (FR) 13 62504

(51) Int. Cl. F23R 3/00; F02C 7/12

(52) U.S. Cl. CPC F23R 3/002; F02C 7/12

(57) ABSTRACT

An annular wall for a turbomachine combustion chamber is disclosed, comprising cooling orifices through which cooling air can circulate through the annular wall, each having an air injection axis oriented orthogonal to a longitudinal axis of the annular wall. The cooling orifices are distributed into first annular rows of cooling orifices oriented in a first circumferential direction from an outer face as far as an inner face of the annular wall, and second annular rows of cooling orifices oriented in a second circumferential direction opposite the first circumferential direction from the outer face as far as the inner face of said annular wall. The first annular rows and the second annular rows of cooling orifices are arranged alternately along the longitudinal axis.

### TECHNICAL DOMAIN

This invention relates to the domain of annular combustion chambers of turbomachines, for example turbomachines fitted on aircraft.

It more particularly relates to cooling air inlet orifices formed in coaxial annular walls of these combustion chambers to create a fresh air film along the hot inner face of these walls.

### STATE OF PRIOR ART

Turbomachines comprise at least one turbine located at the outlet from a combustion chamber to extract energy from a core engine flow ejected by this combustion chamber and to drive a compressor located on the upstream side of the combustion chamber and supplying pressurised air to this chamber.

FIG. 1 appended shows a typical example of a turbomachine combustion chamber 10 comprising two coaxial annular walls, specifically a radially inner wall 12 and a radially outer wall 14, that extend from the upstream towards the downstream direction along the flow direction 16 of the core engine flow in the turbomachine, about the axis 18 of the combustion chamber. These two coaxial annular walls 12 and 14 are connected to each other at their upstream end by an annular chamber end wall 20 extending approximately radially about the above-mentioned axis 18. This annular chamber end wall 20 is equipped with injection systems 22 distributed about the axis 18 to carry an air inlet into the combustion chamber and fuel injection along an injection axis 23.

In general, the combustion chambers include an upstream inner region 24 commonly called the primary zone, and a downstream inner region 26 commonly called the dilution zone.

The primary zone 24 is designed for combustion of the air and fuel mix and is supplied with air not only by injection systems 22 but also through air inlet orifices 28, frequently called “primary orifices” formed in the coaxial walls 12 and 14 in the chamber around the primary zone 24, and distributed in one or several annular rows.

The dilution zone 26 is designed for dilution and cooling of combustion gases and to apply an optimum thermal profile on this gas flow for its passage into the turbine installed on the downstream side of the combustion chamber. At least one row of air inlet orifices 30, currently called “dilution orifices” is formed in the coaxial walls 12 and 14 of the combustion chamber, downstream from the above-mentioned primary orifices 28.

During operation, a part 32 of an air flow 34 from a compressor outlet 36 supplies the injection systems 22 while another part 38 of this air flow bypasses the combustion chamber flowing in the downstream direction along the coaxial walls 12 and 14 of this chamber to supply the primary orifices 28 and dilution orifices 30 in particular.

It is usually necessary to cool the coaxial annular walls 12, 14 of the combustion chambers, considering the high temperatures reached by gases during combustion.

To achieve this, the multi-perforation technique is a known method consisting in providing a plurality of cooling orifices or micro-perforations in some regions of coaxial walls 12, 14 of the combustion chambers. The diameter of these small orifices is usually between 0.3 mm and 0.8 mm, for example equal to 0.6 mm. These cooling orifices usually have an inclined air injection axis relative to the normal to the wall. Some of the relatively cool air flow 38 bypassing such combustion chambers can penetrate into them through these cooling orifices and form a relatively cool air film along the inner faces of the coaxial walls 12 and 14.

Such cooling orifices can be configured to inject cooling air approximately in the axial plane from the upstream to the downstream direction.

However, this configuration does not always result in optimum cooling efficiency of the walls of the combustion chamber, particularly because the residence time of the cooling air in the combustion chamber is too short.

Furthermore, experience has shown that the wake formed by injected air along each longitudinal row of such cooling orifices results in efficient thermal protection of the wall concerned of the combustion chamber, but the cooling air between two longitudinal rows of such cooling orifices is prematurely mixed with combustion gases and cannot give optimum thermal protection of the wall. Thus, traces of soot deposits can usually be observed on the wall of a combustion chamber that has been in operation for some time, between longitudinal rows of cooling orifices.

Another known solution for increasing the residence time of cooling air in the combustion chamber consists of using cooling orifices configured to inject cooling air along a direction approximately orthogonal to the flow of combustion gases in the chamber. Such a solution can also further induce splitting of combustion gas flows close to the wall of the combustion chamber, which is also beneficial for the thermal protection of this wall.

However, it can also be seen that cooling air mixes prematurely with combustion gases between two consecutive circumferential rows of such cooling orifices, and cannot give optimum thermal protection of the wall. Thus, traces of soot deposits can be observed between circumferential rows of cooling orifices on a wall of a combustion chamber that has been in operation for some time.

Furthermore, injection of cooling air along a direction orthogonal to the combustion gas flow can cause gyration of combustion gases about the longitudinal axis of the combustion chamber. Such gyration is usually not desirable considering the profile of the blades arranged at the outlet from the combustion chamber.

Presentation of the Invention

In particular, the purpose of the invention is to provide a simple, economic and efficient solution to this problem, while avoiding most of the above-mentioned disadvantages.

To achieve this, the invention discloses an annular wall for a turbomachine combustion chamber comprising cooling orifices through which cooling air can circulate through the annular wall, each having an air injection axis oriented orthogonal to a longitudinal axis of the annular wall.

The cooling orifices are distributed into first annular rows of cooling orifices oriented in a first circumferential direction from an outer face as far as an inner face of said annular wall, and second annular rows of cooling orifices oriented in a second circumferential direction opposite the first circumferential direction from the outer face as far as the inner face of said annular wall.

According to the invention, the first annular rows and the second annular rows of cooling orifices are arranged alternately along the annular wall.

The first annular rows and the second annular rows of cooling orifices are used for injection of cooling air flow circulating circumferentially in opposite directions, in other words in a counter-rotating way.

In a combustion chamber provided with said annular wall, the gyratory driving effects applied to the combustion gases due to these air flows tend to cancel out, such that the invention largely avoids an induced global gyration component inside these combustion gases. Thus the gyration of these combustion gases at the exit from the combustion chamber may be zero or it may be identical to the gyration that these gases would have in the lack of cooling orifices, depending on the general configuration of this combustion chamber. In both cases, the angle of incidence of combustion gases on blades arranged at the exit from the combustion chamber is thus optimised.

Furthermore, interaction between the cooling air flows circulating in opposite circumferential directions improves the dispersion of this cooling air and therefore the uniformity of cooling of the annular wall. The risk of hotter zones in the annular wall developing during operation is thus reduced.

Finally, injection of cooling air along a direction orthogonal to the longitudinal axis of the annular wall can increase the residence time of this cooling air in the combustion chamber provided with this annular wall in a manner known in itself, and can therefore further improve the cooling efficiency of this annular wall.

The invention thus generally improves the reliability and the life of the annular wall, while reducing its maintenance cost.

This description also discloses a configuration in which the first annular rows and the second annular rows of cooling orifices are distributed into first groups each comprising at least two first annular rows of consecutive cooling orifices, and into second groups each comprising at least two second annular rows of consecutive cooling orifices, the first groups and the second groups being arranged alternately along the annular wall.

In general, the cooling orifices in each annular row are advantageously offset circumferentially from the cooling orifices in consecutive annular rows of cooling orifices such that all cooling orifices are staggered.

Furthermore, the annular wall preferably includes exactly the same number of first annular rows and second annular rows of cooling orifices.

The invention also relates to an annular combustion chamber for a turbomachine, comprising two coaxial annular walls (the inner wall and the outer wall) connected to each other by an annular chamber end wall, and in which at least one of said coaxial annular walls is a wall of the type disclosed above.

Finally, the invention relates to a turbomachine comprising an annular combustion chamber of the type disclosed above.

### BRIEF DESCRIPTION OF THE DRAWINGS

The invention will be better understood and other details, advantages and characteristics of the invention will become clear after reading the following description given as a non-limitative example with reference to the appended drawings in which:

FIG. 1, described above, is a diagrammatic axial half-sectional view of an annular combustion chamber of a turbomachine for a known type of aircraft;

FIG. 2 is a partial diagrammatic top view of a radially outer annular wall for a combustion chamber according to a preferred embodiment of the invention;

FIG. 3 is a partial diagrammatic cross-sectional view along plane III-III in FIG. 2, of the radially outer annular wall in FIG. 2;

FIG. 4 is a view similar to FIG. 2 of a radially outer annular wall for a combustion chamber of a different type, given for information.

Identical references in all these figures may denote identical or similar elements.

### DETAILED PRESENTATION OF PREFERRED EMBODIMENTS

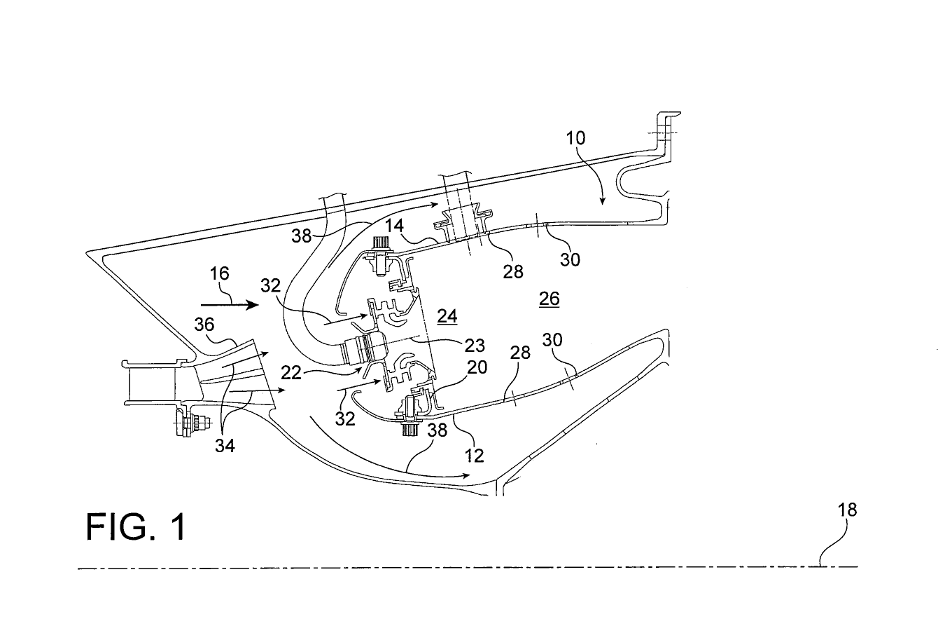

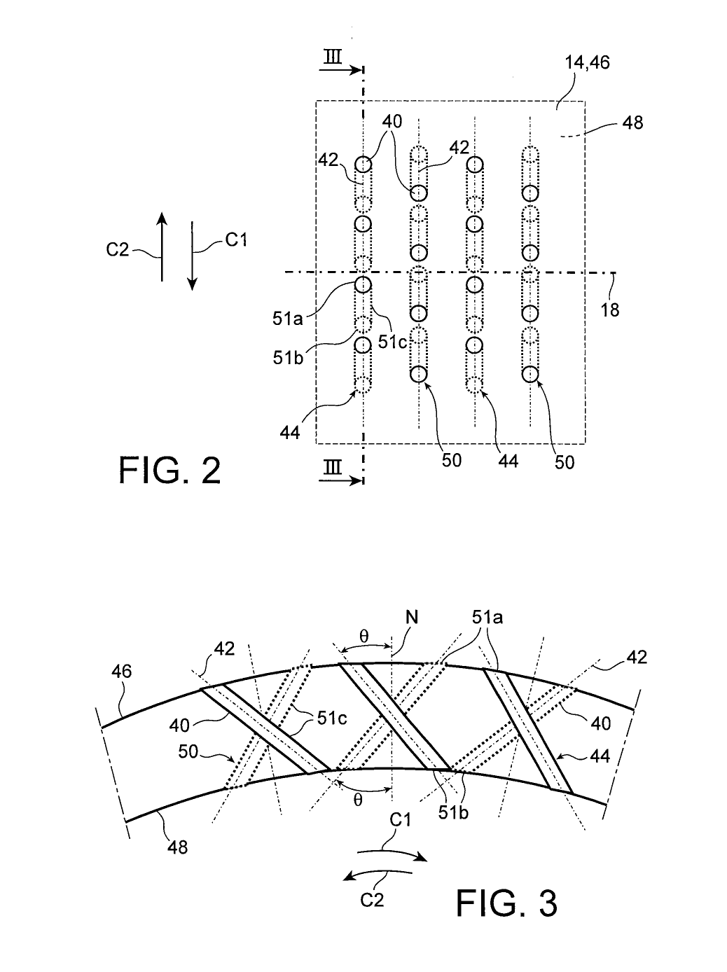

FIGS. 2 and 3 apply to an annular combustion chamber according to a preferred embodiment of the invention, that is globally similar to the combustion chamber in FIG. 1 but that differs from it by the configuration of the cooling orifices formed in the coaxial annular walls of the combustion chamber.

FIGS. 2 and 3 in particular show part of the radially outer annular wall 14 of the combustion chamber.

As can be seen in these figures, the cooling orifices 40 each have an air injection axis 42 oriented orthogonal to the longitudinal axis of the annular wall, said longitudinal axis of the annular wall being coincident with the axis 18 of the combustion chamber.

When the annular wall 14 is seen in a cross-sectional view as in FIG. 3, the air injection axis 42 of each cooling orifice 40 is inclined from the local normal direction N by an angle θ for example equal to about 60 degrees, and more generally between 30 degrees and 70 degrees.

The cooling orifices are distributed into first annular rows 44 of cooling orifices oriented in a first circumferential direction C1 from an outer face 46 up to an inner face 48 of the annular wall 14, and into second annular rows 50 of cooling orifices oriented in a second circumferential direction C2 opposite the first circumferential direction C1 from the outer face 46 as far as the inner face 48 of the annular wall.

In FIG. 2, the radially outer end 51a of each cooling orifice 40 formed in the outer face 46 of the annular wall, is represented by a circle shown in solid lines, while the radially inner end 51b of each cooling orifice 40 formed in the inner face 48 of the annular wall, is shown by a circle drawn in dashed lines. The extension 51c of each cooling orifice 40 in the thickness of the annular wall is also shown in dashed lines.

In FIG. 3, the cooling orifices of a first row 44 are centred in the section plane III-Ill in FIG. 2, and are shown in solid lines. The cooling orifices of a second row 50 located immediately downstream from the section plane are shown in dashed lines.

According to the invention, the first annular rows 44 and the second annular rows 50 of cooling orifices 40 are arranged alternately along the annular wall 14.

In the particular example shown in FIGS. 2 and 3, the cooling orifices 40 of each annular row 44, 50 are offset circumferentially relative to the cooling orifices belonging to consecutive annular rows of cooling orifices, in other words the two annular rows of cooling orifices that are located immediately upstream from and immediately downstream from the annular row of cooling orifices considered. Thus, all cooling orifices are advantageously staggered.

As disclosed above, FIG. 2 only shows a part of the annular wall 14. This annular wall thus comprises a larger number of rows of cooling orifices 40, usually between 10 and 500.

Generally speaking, the first annular rows 44 and the second annular rows 50 of cooling orifices are used for injection of gyratory cooling air flows in opposite directions.

The gyratory driving effects applied to the combustion gases due to these air flows tend to cancel out, such that the invention largely prevents an induced global gyration component within the combustion gases circulating inside the combustion chamber.

The number of first annular rows 44 of cooling orifices is advantageously the same as the number of second annular rows 50 of cooling orifices so as to maximise the counter-rotating effect and thus minimise the induced gyration of combustion gases.

Furthermore, the interaction between cooling air flows circulating in opposite circumferential directions improves dispersion of this cooling air and therefore the uniformity of cooling of the annular wall 14. The risk of hotter zones in the annular wall developing during operation is thus reduced.

Finally, the injection of cooling air along a direction orthogonal to the axis 18 of the combustion chamber can increase the residence time of this cooling air in the combustion chamber in a manner known in itself, and therefore improve the efficiency of cooling the wall considered.

It should be understood that the arrangement of cooling orifices 40 disclosed by the invention does not necessarily apply to the radially outer wall 14 but may apply to the radially inner wall 12 of the combustion chamber, and preferably applies to the two annular walls 12 and 14 simultaneously.

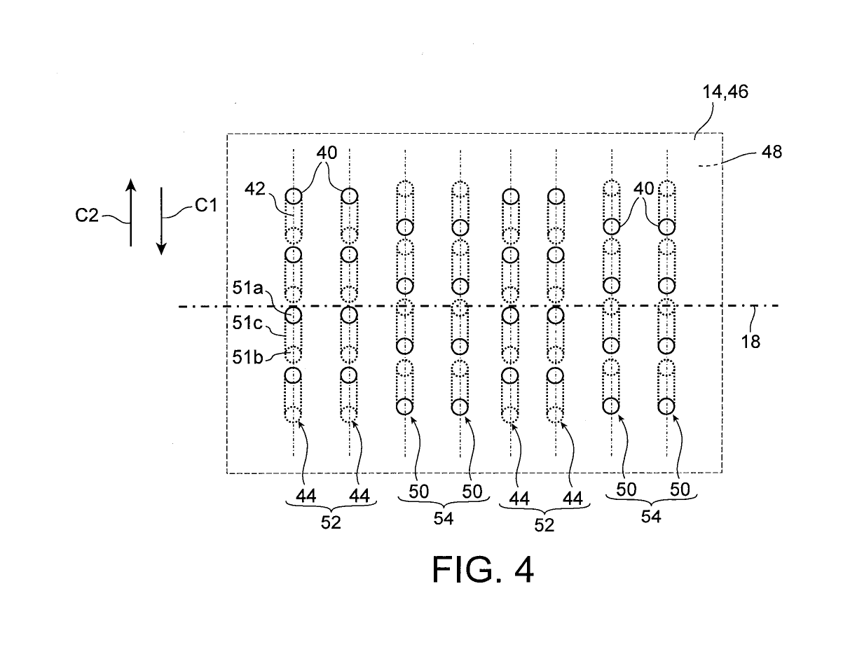

FIG. 4 shows the radially outer annular wall 14 of a combustion chamber of a different type, described for information, in which the first annular rows 44 and the second annular rows 50 of cooling orifices 40 are distributed into first groups 52 each comprising two first consecutive annular rows 44 of cooling orifices, and into second groups 54 each comprising two second consecutive annular rows 50 of cooling orifices. As shown in FIG. 4, the first groups 52 and the second groups 54 are arranged alternately along the annular wall 14. Obviously, there may be more than two annular rows of cooling orifices 40 belonging to each of the first and second groups 52, 54. This number is preferably identical for the two types of groups 52 and 54.

1. Annular wall for a turbomachine combustion chamber comprising cooling orifices through which cooling air can circulate through the annular wall, each having an air injection axis oriented orthogonal to a longitudinal axis of the annular wall, in which the cooling orifices are distributed into first annular rows of cooling orifices oriented in a first circumferential direction from an outer face as far as an inner face of said annular wall, and second annular rows of cooling orifices oriented in a second circumferential direction opposite the first circumferential direction from the outer face as far as the inner face of said annular wall, wherein the first annular rows and the second annular rows of cooling orifices are arranged alternately along the longitudinal axis.

2. Annular wall according to claim 1, in which the cooling orifices in each annular row are offset circumferentially from the cooling orifices in the or each consecutive annular rows of cooling orifices, such that all cooling orifices are staggered.

3. Annular wall according to claim 1, comprising the same number of first annular rows and second annular rows of cooling orifices.

4. Annular combustion chamber for a turbomachine, comprising two coaxial annular walls, namely the inner wall and the outer wall, connected to each other by an annular chamber end wall, characterised in that at least one of said coaxial annular walls is a wall according to claim 1.

5. Turbomachine, including an annular combustion chamber according to the previous claim.
